(19) United States
(12) Patent Application Publication
(10) Pub. No.: US 2024/0221055 A1
(43) Pub. Date: Jul. 4, 2024

(54) SYSTEM AND METHOD FOR A JUST IN TIME RECOMMENDATION ENGINE FOR ITEMS ALONG A TRAVEL PATH FOR A VEHICLE

(71) Applicant: MAVI.io Inc., Miami, FL (US)

(72) Inventors: Vamsi Putrevu, San Ramon, CA (US); Cynthia Hollen, Hollywood, FL (US)

(21) Appl. No.: 18/402,806

(22) Filed: Jan. 3, 2024

Related U.S. Application Data
(60) Provisional application No. 63/478,362, filed on Jan. 4, 2023.

(51) Int. Cl. G06Q 30/0601; G01C 21/36; G06Q 10/083; G06Q 20/34; G08G 1/14

(52) U.S. Cl. CPC G06Q 30/0631; G01C 21/3679; G06Q 10/083; G06Q 20/34; G08G 1/146

(57) ABSTRACT

Vehicle onboard navigation systems determine current location and projected future location. A first database stores the identity of vendors, current inventory of vendor goods, and vendor hours of operation. A second database stores driver preferences, including vendor location for a preferred vendor, preferred vendor items, and payment preference. A processor communicates with the first database, second database, navigation system, and interface, and receives the command from an interface, including a type of good, and in response determines a current vehicle position, and an arc corresponding to a physical area about the vehicle position along the route. The processor, communicating with the first database, determines vendors within the arc; selects a vendor using of the driver preference, vendor location, make time and arrival time at a future location; and initiates an order for the good as a function of vendor location, make time and arrival time.

### CROSS REFERENCE TO RELATED APPLICATION

This application claims prior to U.S. Provisional Application No. 63/478,362 filed Jan. 4, 2023, the contents of which are herein incorporated as if fully set forth herein.

### BACKGROUND OF THE INVENTION

The present invention is directed to a system and method for recommending goods to a person on the move, and more particularly for recommending products on the fly as a function of a current geographic location and a geographic location in the future while a user is in transit.

It is known in the art to call ahead and order food from a restaurant. One simply places an order, and is given a time of pick up. One then travels to the restaurant, gets out of the car, pays, gets back in the car and returns to their destination. This prior art system has existed since the advent of the car, if not the phone, and has been satisfactory. However, it suffers from the disadvantage that one is limited to the restaurants known to the purchaser, or even more limiting, stored on their phone. It also suffers from the disadvantage that it is tied to restaurants and geographic locations known to the user ahead of time. It also requires the purchaser to get out of the car, pay for the order and pick up the order.

It is known in the art to enable a mobile device, such as a phone to make recommendations for goods in geographic area; even one corresponding to a current location. An application on a phone may return a response to a search for McDonald's® within a predetermined distance from a current location of the phone. The response takes the form of a map and the locations on the map of each of the requested restaurants. While this application is satisfactory, it suffers from the shortcomings that it does not order the food, or if it does enable selection of items for order, it requires selecting the restaurant and location first, scrolling the menu and then ordering and paying; a number of cumbersome steps.

Furthermore, where enabled, if the user interface, or even the phone call enabled the purchaser to pay using the phone, or announce their proximity, it suffers from the disadvantage that it requires distracting activities by the user of the phone. In a car environment, while travelling to the restaurant, this causes unsafe distracting conditions.

It is also known in the art, to select a known store, such as Walmart® and pre-order and pay for goods for pick up. The ordered goods are then available to be picked up at the chosen store at some time in the future. In most instances, the purchaser goes to a dedicated spot within the store for the goods, and in some instances the bundle of goods may be delivered to the purchaser curbside. This system has been satisfactory, however it suffers from the disadvantage that the user must select the store location ahead of time, and then is a prisoner of the geography of the store for the window of time necessary to prepare the bundle of goods. In effect to prevent spoilage, the purchaser must be willing to be at the fixed store location some fixed time in the future, significantly curtailing their freedom to move. There is no current just in time system or methodology which can be made use of for decisions to purchase made while in transit.

Accordingly, a structure and methodology for ordering goods while moving, particularly while driving an automobile, which overcomes the shortcomings of the prior art is desired.

### SUMMARY OF THE INVENTION

A system for providing recommendations for requested goods to a vehicle in transit includes a vehicle. The vehicle has an onboard navigation system for determining a current location and projected future location. The projected future location can be selected on the map via a tap on a “pin”, the “pin” would indicate a geo-hash. The vehicle has an interface for entering an instruction. A first database stores the identity of one or more vendors, a current inventory of goods of each of the one or more vendors, and an hours of operation of the one or more vendors. A second database stores driver preferences, the driver preferences including a vendor location for a preferred vendor, one or more preferred items associated with each vendor, and a user payment preference. The second database will also store a driver's current location and the computed grid which contains the driver location. A processor communicates with the first database, the second database, the navigation system, and interface. The interface receiving a command from within the vehicle, the command including a type of good. The processor receiving the command, and in response thereto receives a current position of the vehicle and direction/route, and determines an arc projecting from the vehicle. The arc corresponds to a physical area about a physical position of the vehicle along the route. The processor communicating with the first database and determining the one or more vendors within the arc having the good. The processor communicating with the first database and selecting a vendor as a function of the driver preference, vendor location, make time and a time to arrive at a future vehicle location; the processor initiating an order for the good as a function of the vendor location and one or more of the make time and travel time.

In another embodiment the parking lot of the vendor includes parking spaces. Each parking space has a location. The vehicle broadcasts the location of the vehicle relative to a parking spot upon arrival at the vendor.

In yet another embodiment of the invention user payment information such as information for enabling electronic payment or credit card payment is stored in the second database. The processor enabling payment of the vendor utilizing the payment information upon one of an arrival of the vehicle at the vendor or completion of placement of the order.

In still another embodiment of the invention, the system determines a first length of time required for the vehicle to travel from a current position of the vehicle to the vendor. The system determines a second length of time necessary to fulfill the order and if the second length of time is less than the first length of time the system delays the beginning of preparation of the order In still another embodiment of the invention, the system determines a first length of time required for the vehicle to travel from a current position of the vehicle to a closest vendor having the item. The system then determines a closest vendor as a function of the arrival time substantially matching the complete preparation time.

### BRIEF DESCRIPTION OF THE DRAWINGS

The present disclosure will be better understood by reading the written description with reference to the accompanying drawing figures in which like reference numerals denote similar structure and refer to like elements throughout in which:

FIG. 1 is an operational diagram of the system constructed in accordance with the invention;

FIG. 2 is a diagram of a method of operating the system in accordance with the invention for provisioning goods from a moving automobile; and

FIG. 3 is a graphical representation of a path to be used by a vehicle as determined by the system in accordance with the invention in accordance with the invention;

### DETAILED DESCRIPTION OF THE PREFERRED EMBODIMENTS

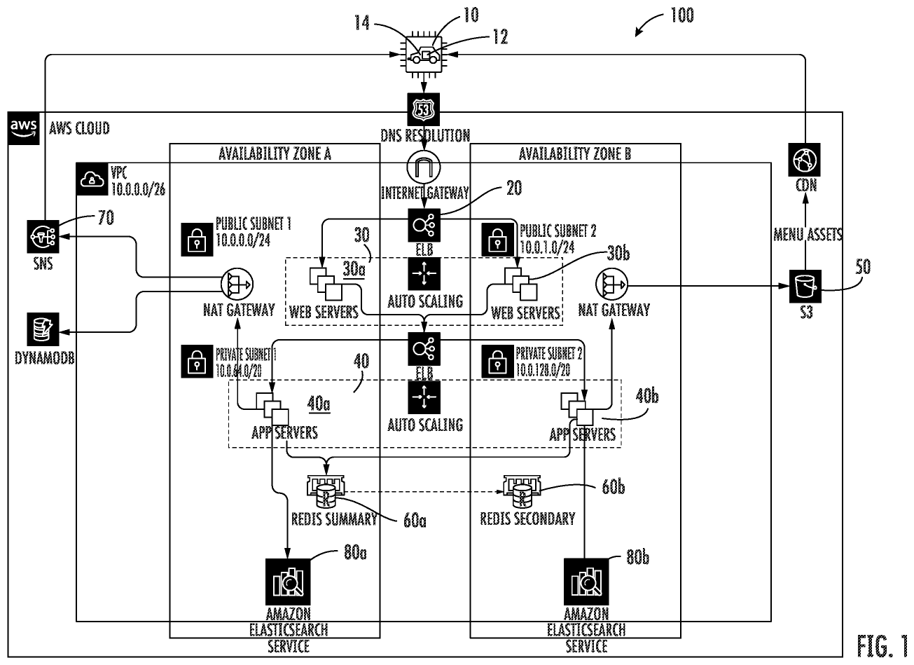

Reference is first made to FIG. 1 in which a system 100 for making just in time recommendations to a vehicle in transit is provided. For the purpose of this description a “just in time” recommendation or order is an order for an item for which the preparation and packaging of the order is substantially completed at the time of vehicle arrival at the location of the item. System 100 includes a vehicle 10. A navigation system 12 capable of determining a vehicle travel path, the vehicle travel path having a current vehicle location and a travel end location. The navigation system 12 is disposed on the vehicle 10. By way of non-limiting example the end location may be the user's home, their office or any destination entered into the system or estimated based on past behavior and/or direction if not destination selected. The navigation system 12 projecting an arc along the vehicle travel path, the arc being a navigation construct bounding an area of interest along the vehicle travel path.

System 100 includes an interface 14 disposed on vehicle 10. The interface 14 is enabled to receive instructions, including a trigger command from a user in vehicle 10. The input, in a preferred non limiting embodiment, may be an oral (“audio”) input using a trigger command, but the input trigger signal may also be manual; using a graphical user interface (“GUI”) on the vehicle 10, or a mobile device such as a smart phone traveling with the vehicle 10. A processor, which may be on board vehicle 10, in the cloud such as web servers 30 and app servers 40, or some combination thereof receives the trigger command.

Vendor information such as the identity of one or more vendors, a current inventory of goods of each of the one or more vendors, a location of the one or more vendors and an hours of operation of the one or more vendors are stored in a first database 80, which again may be more than one database such as databases 80a, 80b; preferably in the cloud. In other embodiments vendor information may include information such as vendor ratings such as known from YELP®, physical plant information such as are there restrooms?, how well-lit is the pickup area?, is there seating for eating, or the presence of charging stations for electric vehicles by way of non-limiting examples.

User preferences for certain goods, such as a favorite meal, like a hamburger, pizza or vegan, and even more particularly a favorite vendor, as a function of purchase history, menu or location by way of non-limiting example, of that meal; such as BurgerFi® are stored in a second database 60, which again may be more than one database 60a, 60b. This information may be stored for a variety of products, price ranges, available dining accommodations, vendors and payment methods, not just the food example above. Additionally, the second database 60 may store a vendor location for a preferred vendor, one or more preferred items associated with each vendor, and a user payment preference. For user preference database 60 may store credit card information, debit card information, or account access information for electronic payment such as Zell®, Venmo®, even tokens, cryptocurrency or the like.

Vehicle 10 is an internet of things enabled vehicle and communicates through an internet gateway 20 with a cloud-based web server 30. In a preferred, non-limiting, embodiment web server 30 may be formed of two or more web servers 30a, 30b operating under the control of a load balancer for balancing the load amongst the plurality of web servers. Web server 30 receives a request from vehicle 10 from interface 14. The request includes certain keywords, such as the item the user wishes to obtain. For example, the request may be for a “Hamburger”. It should be noted that the request may be for other foods such as pizza, or milk which changes the potential vendor, or even nonfood items such as “toilet paper”. In a preferred nonlimiting embodiment, interface 14 is an audio interface always looking for a trigger word/phrase such as a fanciful word or name, or functional commands such as “I'm Hungry” or “get me a” to activate the audio interface to process the next keyword(s). However, in another non limiting embodiment interface 14 may be a GUI input having an enablement button on screen beginning the process as an on screen process.

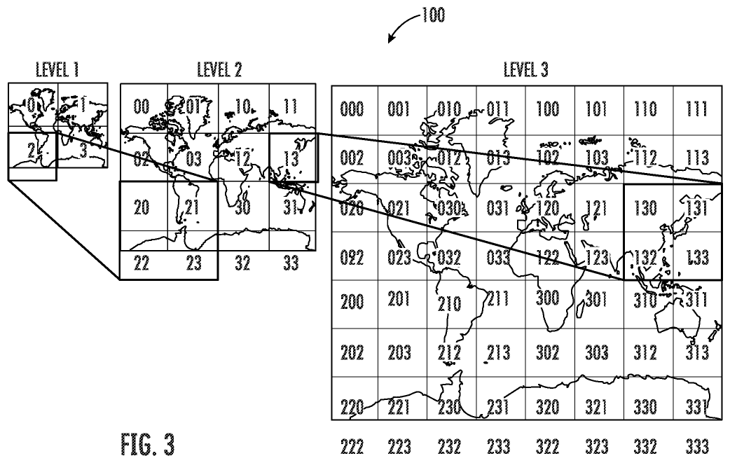

In accordance with the invention the area of interest through which any vehicle 10 is geo hashed as seen in FIG. 3 by way of nonlimiting example. As a result, the more areas which are added, the greater specificity for the system. The location of the vehicle will always be tagged to one of the grids 1000, shown in FIG. 3, corresponding to a physical area. As shown, as specificity increases the number of grids associated with an area becomes greater. Grid 2 in Level 1 becomes four grids 020-023 in Level 2 and each grid in level 2 becomes eight grids at Level 3 and so on.

As vehicle 10 begins a journey system 100 will cache, in memory on board vehicle 10, or in application servers 40, all reachable locations from a current location grid of the vehicle.

At periodic intervals system 100 tags all vendors within a location (on the grid within a projected arc of travel) with their make time. This is the time necessary for a vendor to fulfill an order. The make time, for preparing the ordered item, along with a projected travel time, time for each reachable location is used as a weighting factor for recommendations to the vehicle in response to an order.

During use, system 100 receives periodic pings regarding the physical location of the vehicle 10 in transit In a preferred non limiting embodiment these are longitude and latitude readings. Using a library, available through the cloud, in a database associated with and personalized to vehicle 10, system 100 determines in which a grid 0-333 of grids 1000 vehicle 10 is located and updates the location in in second database 60.

In one preferred embodiment, geo hashing is used to determine the grids used by the system. As seen in FIG. 3, geo hashing is an encoding mechanism based on latitude and longitude. The core concept imagines the earth as a flattened surface. The surface is divided into multiple grids, preferably square, the region becoming smaller as grids are added. The precision of the area also increases inversely with grid size and the length of the string representing the areas increases. In accordance with the invention the density of locations within the grid will determine the breakdown of the grids.

The location of vehicle 10 is tagged to one of the grids 1000 by the processor. When vehicle 10 begins a journey and moves across grids 1000, the processor will cache all reachable locations from the current grid within a reachable time. Reachable time is a function of routes, speed limits, and traffic.

Upon the making of a request for an item to system 100, system 100 determines the neighboring grids 100 to the grid in which vehicle 10 is currently located. In a preferred nonlimiting embodiment this is performed at a level in which a current grid for car 10 is bounded by eight grids 100. With these nine regions, the vehicle region and eight bounding regions, system 100, utilizing search criteria, limited to the forward direction along the route in a preferred non limiting embodiment, as a function of the request, make time, travel time and stored user preferences, sends inquiries as a function of each region, for vendors potentially meeting the user request criteria.

Those vendors in the system are then ranked as function. The responses are then ranked by system 100 weighted as a function of the criteria above. The appropriate recommendations are returned to the dashboard of vehicle 10 for either a verbal or GUI confirmation.

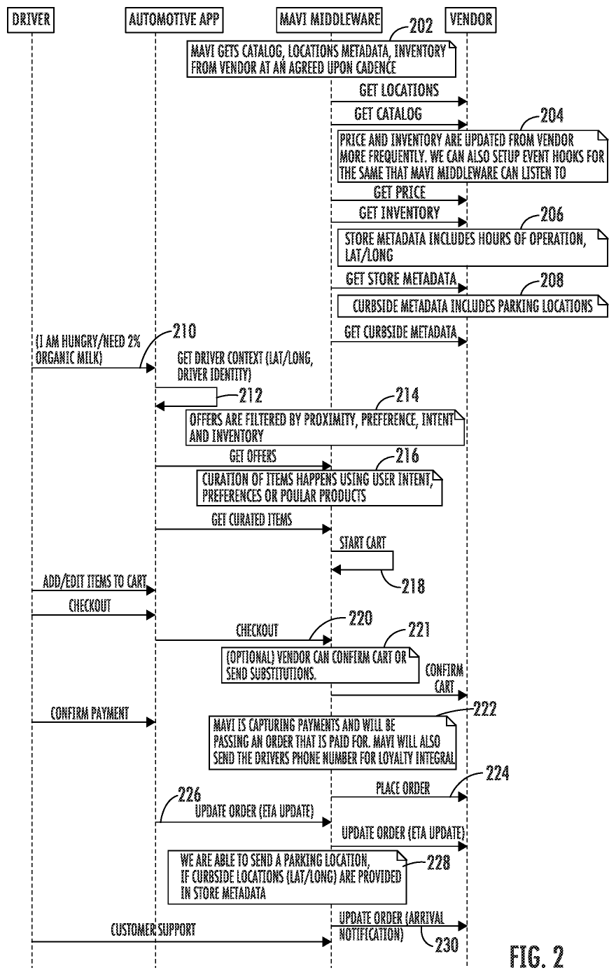

Reference is now made to FIG. 2 in which the process for operating the system in accordance with the invention is described with greater particularity. As will be seen the system 100 is initialized in steps 202-208. In accordance with a step 202, the identity of the participating vendors, their respective inventories, pricing and respective physical locations within grid 1000 are downloaded to system 100 and stored, by way of non-limiting example at web servers 30.

System 100 is continuously, or at predetermined frequency polling each vendor to determine whether the vendor has changed operating hours, inventory, or pricing. In a step 204, as necessary, the inventory data, such as availability and pricing is updated as needed and stored at web server 30. In a step 206 the physical location of the store (if a pop up, or food truck) and its operating hours are updated. In a preferred non limiting embodiment, the locations of parking spots adjacent to the vendor are stored in a step 208 with their necessary metadata.

Part of the initialization process also includes the storing of user preferences including, but not limited to, preferred vendors, as a function of product. For example, a user's preferred hamburger vendor may not be its preferred vendor for coffee or chicken sandwiches. These preferences may be stored on board vehicle 10 or as part of the distributed network of system 100.

Reference is now made to steps 210 through 224 in which system 100 is used to place an order for an item. In a step 210, the user initiates the process by triggering system 100 using a tactile input in an onboard device, either on the vehicle dashboard, or a phone or the like carried in vehicle 10, or an oral command received at an audio embodiment of interface 14. In an oral trigger embodiment, the trigger may be “I'm Hungry” or any other randomly selected command. This phrase may then be followed by the one or more items actually desired, such as a pepperoni pizza and a bottle of soda. Similarly, based on stored information about the user, interface 14 in a GUI embodiment, an onboard device offers a menu of items to be manually selected. In a step 212 the navigation system 12 determines the longitude and latitude of the vehicle 10 and the grid 2 to which it corresponds. It also determines the identity of the person making the request. This may be done by oral recognition, or an identifier input at the beginning of trip, or may default to a single driver most likely to use the vehicle 10.

In a step 214 vendor products are filtered as function of the stored user preferences (preferred vendor), proximity, make time, projected travel time, and availability (item in stock, operating hours). In a step 218 these curated items, are presented to the driver. It should be noted that if the driver merely states “I'm Hungry”, system 100 may present a pizza, a hamburger and a chicken wings, from preferred vendors as a choice of several goods.

The presented items may be modified by the driver. Once completed the driver checks out either orally or by GUI in a step 220 and the order is further processed by system 100. In a preferred nonlimiting embodiment, in a step 221, the vendor may confirm the cart as ordered or introduce substitutions to the user as needed.

In a step 222 the payment information, as stored by system 100, is combined with the order. Loyalty club information such as phone number, Member ID, e-mail or the like may also be gathered by system 100. Then in a step 224 system 100 places the order with the selected vendor.

Utilizing navigation system 12, vehicle 10 regularly, at predetermined intervals, updates its position as known in the art. This updated position is transmitted to the vendor to update the estimated time of arrival (“ETA”). In a step 228 system 100 transmits an arrival or parking location for arriving vehicle 10 to which the vendor delivers the order. In a step 230 system 100 making use of navigation system 12, or other telemetrics, sends a notification to the vendor that vehicle 10 has arrived at the vendor and more particularly at the assigned parking spot.

As can be seen by providing a system in accordance with invention above, drivers of vehicles now have location, ordering, product recommendation, payment and pick up coordination.

It should be further recognized that the invention is not limited to the particular embodiments described above. Accordingly, numerous modifications can be made without departing from the spirit of the invention and scope of the claims appended hereto.

1. A system for providing recommendations for requested goods to a vehicle in transit comprising:
a vehicle, the vehicle having navigation system thereon, the navigation system being configured to determine a current location and projected future location of the vehicle;
a first database, the first database being configured to store the identity of one or more vendors, the location of the one or more vendors, a current inventory of goods of each of the one or more vendors, and an hours of operation of the one or more vendors;
a second database, the first database being configured to store driver preferences, the driver preferences including a vendor location for a preferred vendor, one or more preferred items associated with each vendor, and a user payment preference;
a processor communicating with the first database, the second database, the navigation system; and
an interface; the interface receiving a command, the command including a type of good; the processor, being configured to receive the command, and in response thereto obtaining a current position of the vehicle, and determining an arc projecting from the vehicle, the arc corresponding to a physical area about a physical position of the vehicle along the route; the processor communicating with the first database and determining the one or more vendors having a location within the arc having the type of good; and the processor communicating with the first database and selecting a vendor as a function of the driver preference, vendor location, make time and a time to arrive at a future vehicle location; the processor initiating an order for the good as a function of the vendor location and one or more of the make time and travel time.

2. The system for providing recommendations of claim 1, wherein a vendor location includes a parking lot, the parking lot being divided into one or parking spaces associated with the vendor location, each parking lot space corresponding to an identified parking lot space, the vehicle broadcasting a location of the vehicle to the vendor upon arrival at the parking lot space.

3. The system for providing recommendations of claim 1, wherein a vendor location includes a parking lot, the parking lot being divided into one or parking spaces associated with the vendor location, each parking lot space corresponding to an identified parking lot space, the processor assigning a time of arrival and parking lot space to the vehicle, and broadcasting the assigned parking lot space to the vehicle, the good being delivered to the assigned parking lot space.

4. The system for providing recommendations of claim 1, wherein the user payment preference associated with the vehicle is one of electronic payment and credit card, the user payment being before the vehicle arrives at the vendor location.

5. The system for providing recommendations of claim 1, wherein the processor processes payment as a function of the user preference prior to the vehicle arriving at the vendor.

6. The system for providing recommendations of claim 1, wherein the processor determines a travel time and a make time for the good and where the travel time exceeds the make time, determining a delay time for making the good to best coincide the make time and arrival time.
